(19) United States
(12) Patent Application Publication
(10) Pub. No.: US 2025/0238600 A1
(43) Pub. Date: Jul. 24, 2025

(54) SYSTEMS AND METHODS FOR AUTOMATIC DATA LABELLING USING ANNOTATION MATERIALS

(71) Applicant: JPMORGAN CHASE BANK, N.A., New York, NY (US)

(72) Inventors: Thomas WALSHE, London (GB); Fanny SILAVONG, London (GB); Sae Young MOON, Edmonton (CA); Yawwani GUNAWARDANA, Eastleigh (GB)

(21) Appl. No.: 19/034,243

(22) Filed: Jan. 22, 2025

Related U.S. Application Data
(60) Provisional application No. 63/624,536, filed on Jan. 24, 2024.

(51) Int. Cl. G06F 40/169; G06F 16/383

(52) U.S. Cl. CPC G06F 40/169; G06F 16/383

(57) ABSTRACT

A method may include: receiving a dataset comprising a plurality of label names and a label description for each label name; prompting a large language model (LLM) for initial annotation guidelines with the dataset; receiving, from the LLM, the initial annotation guidelines; receiving an unlabeled dataset comprising unlabeled text samples; predicting a label name for each unlabeled text sample; presenting each unlabeled text sample and its predicted label name for review; grouping incorrectly labeled text samples and their predicted label names; prompting the LLM for a recommendation to improve the initial annotation guidelines with the group of the incorrectly labeled text samples and their predicted label names and the initial annotation guidelines; receiving, from the LLM, the recommendation; prompting the LLM for improved annotation guidelines with the initial annotation guidelines and the recommendation; receiving the improved annotation guidelines; and deploying the improved annotation guidelines to a production environment.

### RELATED APPLICATIONS

This application claims the benefit of, and priority to, U.S. Provisional Patent Application Ser. No. 63/624,536, filed Jan. 24, 2024, the disclosure of which is hereby incorporated, by reference, in its entirety.

### BACKGROUND OF THE INVENTION

### 1. Field of the Invention

Embodiments relate generally to systems and methods for automatic data labelling using annotation materials.

### 2. Description of the Related Art

Supervised machine learning algorithms for the classification of natural language rely on the availability of labelled data for training and testing. For tasks where training data does not already exist, labels must be added by human annotators or Subject Matter Experts (SMEs). The process of manual annotation is slow and prone to human errors.

As part of an annotation project to create a new labelled dataset, annotation materials must be created and updated to reflect the desired separation of the data from the business. These materials include written descriptions of label names and annotation guidelines that instruct annotators on how to correctly assign label names given a set of criteria.

### SUMMARY OF THE INVENTION

Systems and methods for automatic data labelling using annotation materials are disclosed.

In one embodiment, methods to automatically improve annotation guidelines comprising a multi-agent system of Large Language Model (LLM)-based agents for guideline creation and improvement, data annotation, and review are disclosed. A self-improvement mechanism using annotation feedback may be used to update generated guidelines.

In embodiments, methods to improve the accuracy of artificial intelligence (AI)-based data labelling comprising a weakly supervised label model trained using annotation materials (e.g., guidelines, label name descriptions, etc.) are disclosed. Multiple generated variants of annotation guidelines may be used for prediction during weak supervision.

In embodiments, methods to increase the speed of AI-based data labelling comprising a retrieval system for ranking and selecting suitable candidate label names prior to labelling are disclosed. The semantic similarity between a data sample and annotation guidelines may be used to produce a ranking over candidate label names.

According to one embodiment, a method may include: (1) receiving, by a computer program executed by a computer processor, a dataset comprising a plurality of label names and a label description for each label name; (2) prompting, by the computer program, a large language model (LLM) for initial annotation guidelines with the dataset; (3) receiving, by the computer program and from the LLM, the initial annotation guidelines; (4) receiving, by the computer program, an unlabeled dataset comprising unlabeled text samples; (5) predicting, by the computer program, a label name for each unlabeled text sample; (6) presenting, by the computer program, each unlabeled text sample and its predicted label name for review; (7) grouping, by the computer program, incorrectly labeled text samples and their predicted label names; (8) prompting, by the computer program, the LLM for a recommendation to improve the initial annotation guidelines with the group of the incorrectly labeled text samples and their predicted label names and the initial annotation guidelines; (9) receiving, by the computer program and from the LLM, the recommendation; (10) prompting, by the computer program, the LLM for improved annotation guidelines with the initial annotation guidelines and the recommendation; (11) receiving, by the computer program, the improved annotation guidelines; and (12) deploying, by the computer program, the improved annotation guidelines to a production environment.

In one embodiment, the step of predicting, by the computer program and using an annotation agent, the label name for each unlabeled text sample comprises: obtaining, by the annotation agent and using a sentence transformer, a semantic embedding for each unlabeled sample text and for the label names; ranking, by the annotation agent and for each unlabeled sample text, the label names based on a similarity between the semantic embeddings; and identifying, by the annotation agent, one of the label names for each unlabeled sample text as the predicted label name.

In one embodiment, the similarity comprises a cosine similarity.

In one embodiment, a number of ranked label names is limited.

In one embodiment, each unlabeled text sample and its predicted label name are presented for review to a human.

In one embodiment, each unlabeled text sample and its predicted label name is identified as correctly labeled or incorrectly labeled.

In one embodiment, multiple versions of the annotation guidelines are used in the production environment to predict label names, and a label model combines the predicted label names and outputs a final predicted label name.

According to another embodiment, a system may include: a database comprising a dataset comprising a plurality of label names and a label description for each label name; a large language model (LLM); and a computer program executed by an electronic device that is configured to receive the dataset from the database; prompt the LLM for initial annotation guidelines with the dataset; receive, from the LLM, the initial annotation guidelines; receive an unlabeled dataset comprising unlabeled text samples; predict, a label name for each unlabeled text sample; present each unlabeled text sample and its predicted label name for review; group incorrectly labeled text samples and their predicted label names; prompt the LLM for a recommendation to improve the initial annotation guidelines with the group of the incorrectly labeled text samples and their predicted label names and the initial annotation guidelines; receive, from the LLM, the recommendation; prompt the LLM for improved annotation guidelines with the initial annotation guidelines and the recommendation; receive the improved annotation guidelines; and deploy the improved annotation guidelines to a production environment.

In one embodiment, predicting the label name for each unlabeled text sample comprises: obtaining, using a sentence transformer, a semantic embedding for each unlabeled sample text and for the label names; ranking, for each unlabeled sample text, the label names based on a similarity between the semantic embeddings; and identifying one of the label names for each unlabeled sample text as the predicted label name.

In one embodiment, the similarity comprises a cosine similarity.

In one embodiment, a number of ranked label names is limited.

In one embodiment, each unlabeled text sample and its predicted label name are presented for review to a human.

In one embodiment, each unlabeled text sample and its predicted label name is identified as correctly labeled or incorrectly labeled.

In one embodiment, multiple versions of the annotation guidelines are used in the production environment to predict label names, and a label model combines the predicted label names and outputs a final predicted label name.

According to another embodiment, a non-transitory computer readable storage medium may include instructions stored thereon, which when read and executed by one or more computer processors, cause the one or more computer processors to perform steps comprising: receiving a dataset comprising a plurality of label names and a label description for each label name; prompting a large language model (LLM) for initial annotation guidelines with the dataset; receiving, from the LLM, the initial annotation guidelines; receiving an unlabeled dataset comprising unlabeled text samples; predicting a label name for each unlabeled text sample; presenting each unlabeled text sample and its predicted label name for review; grouping incorrectly labeled text samples and their predicted label names; prompting the LLM for a recommendation to improve the initial annotation guidelines with the group of the incorrectly labeled text samples and their predicted label names and the initial annotation guidelines; receiving, from the LLM, the recommendation; prompting the LLM for improved annotation guidelines with the initial annotation guidelines and the recommendation; receiving the improved annotation guidelines; and deploying the improved annotation guidelines to a production environment.

In one embodiment, the non-transitory computer readable storage medium may also include instructions stored thereon, which when read and executed by the one or more computer processors, cause the one or more computer processors to predict the label name for each unlabeled text sample by: obtaining, using a sentence transformer, a semantic embedding for each unlabeled sample text and for the label names; ranking, for each unlabeled sample text, the label names based on a similarity between the semantic embeddings; and identifying, one of the label names for each unlabeled sample text as the predicted label name.

In one embodiment, the similarity comprises a cosine similarity.

In one embodiment, a number of ranked label names is limited.

In one embodiment, each unlabeled text sample and its predicted label name are presented for review to a human, and each unlabeled text sample and its predicted label name is identified as correctly labeled or incorrectly labeled.

In one embodiment, multiple versions of the annotation guidelines are used in the production environment to predict label names, and a label model combines the predicted label names and outputs a final predicted label name.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system of automatic data labelling using annotation materials according to an embodiment;

FIGS. 2A and 2B depict a method to automatically improve annotation guidelines according to an embodiment;

FIG. 3 depicts an exemplary annotation process according to an embodiment;

FIG. 4 depicts an exemplary computing system for implementing aspects of the present disclosure.

### DETAILED DESCRIPTION OF PREFERRED EMBODIMENTS

Embodiments relate generally to systems and methods for automatic data labelling using annotation materials.

Embodiments may use AI-based methods to improve the way that annotation guidelines are created, updated, and maintained.

Embodiments may leverage AI to use annotation guidelines and annotation materials to automatically and accurately label data.

Embodiments may accelerate AI and human-based annotation by pre-selecting the guidelines of label names that are highly likely to be related to the true label name of a data sample.

Embodiments may generate annotation materials that contain information suitable to annotate text.

Embodiments may use variations of annotation materials in weakly supervised label model.

Embodiments may select semantically related label names for annotation.

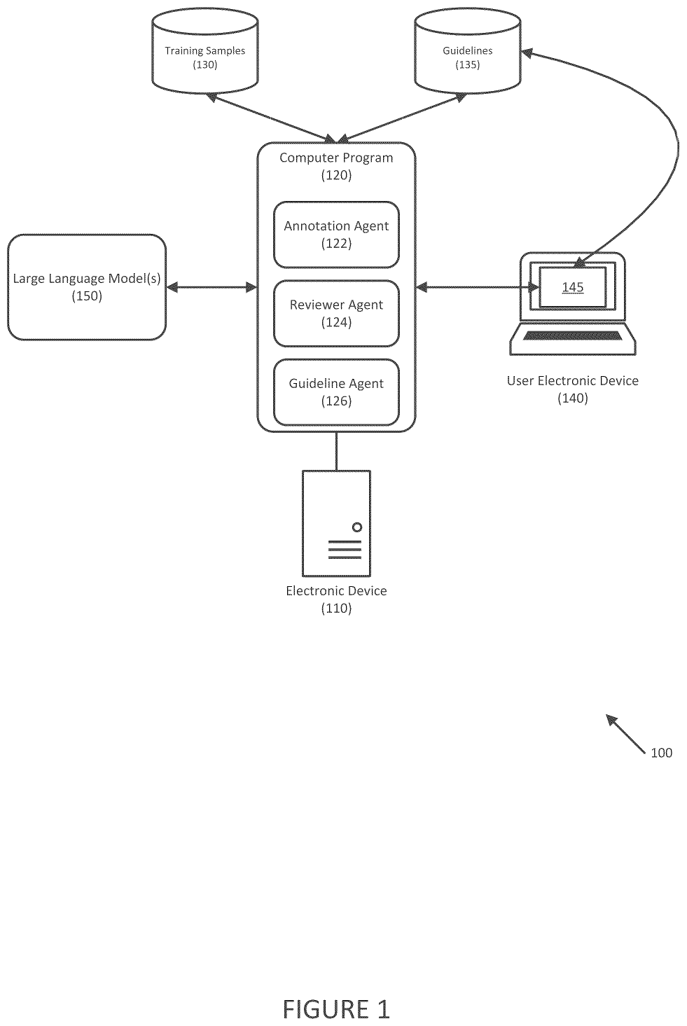

Referring to FIG. 1, a system for automatic data labelling using annotation materials is disclosed according to an embodiment. System 100 may include electronic device 110, which may be a server (e.g., physical and/or cloud-based), a computer (e.g., workstation, desktop, laptop, notebook, tablet, etc.), a smart device, an Internet of Things appliance, etc. Electronic device 110 may execute computer program 120, which may include a plurality of agents. For example, computer program 120 may include annotation agent 122, reviewer agent 124, and guideline agent 126.

System 100 may further include large language model 150. Large language model 150 may be a transformer-based large language model, and may receive prompts from annotation agent 122, reviewer agent 124, and guideline agent 126.

An example of a suitable LLM is Mistral 7B.

In one embodiment, a single large language model 150 may be provided, and annotation agent 122, reviewer agent 124, and guideline agent 126 may use the same large language model 150. In other embodiments, multiple large language models (not shown) may be provided.

Computer program 120 may receive training samples from training sample database 130, and guidelines from guideline database 135.

System 100 may further include user electronic device 140, which may be a computer, a smart device, etc. User electronic device 140 may execute user computer program 145. User computer program 145 may provide annotation guidelines for guideline database 135, and may also interface with computer program 120 to provide manual review and feedback of generated labels.

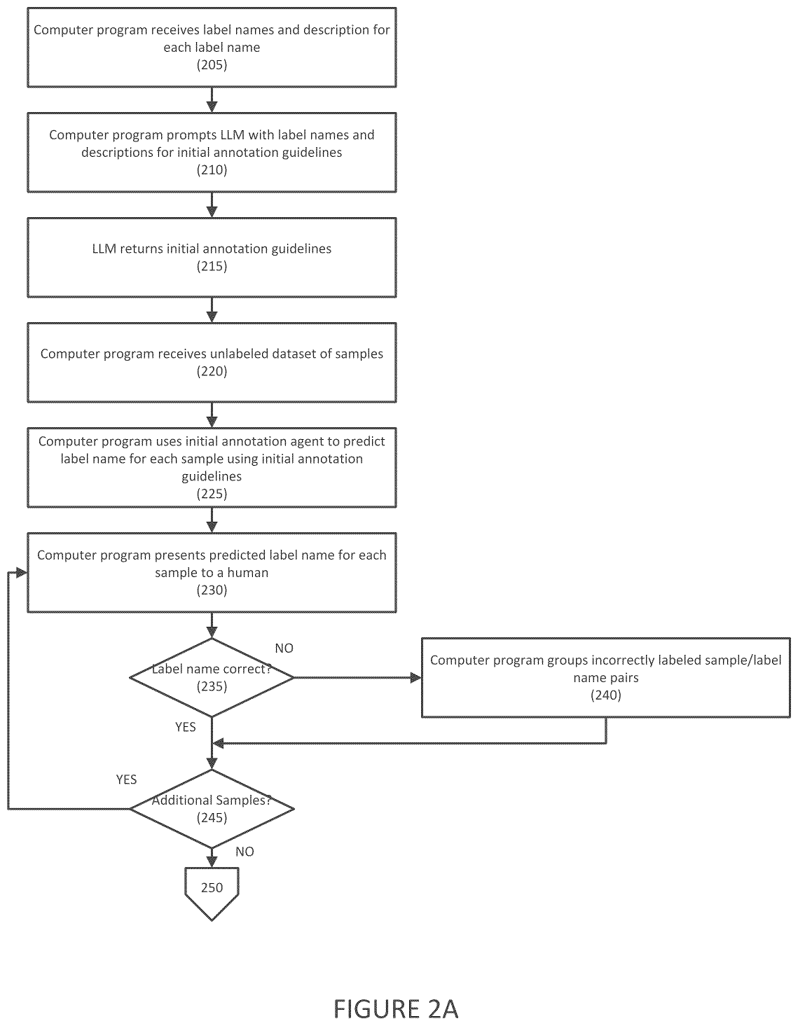

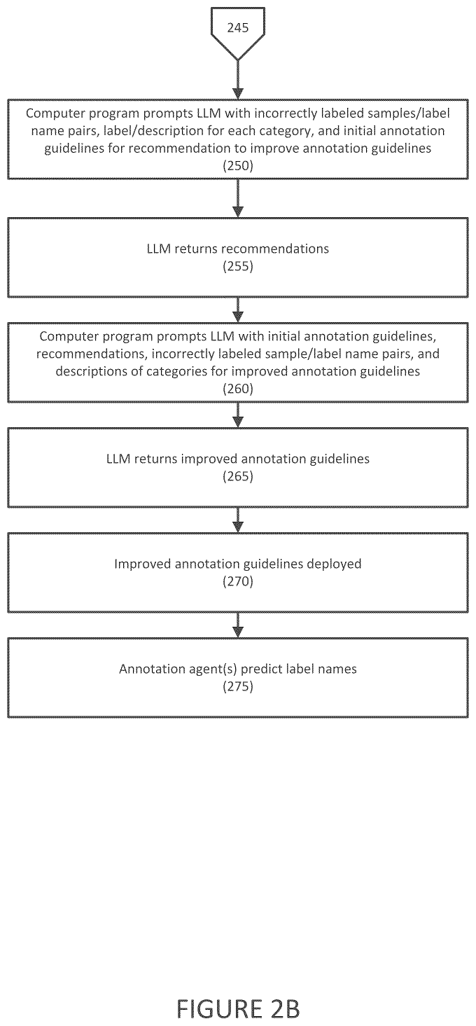

Referring to FIGS. 2A and 2B, a method to automatically improve annotation guidelines is disclosed according to an embodiment.

In step 205, a computer program may receive a dataset of label names and a description for each label name. In one embodiment, additional metadata may also be received. The label information may be provided by a business or users. For example, given a dataset of customer chat conversations, labels may be defined as types of inquiries or complaints that the users are interested in monitoring. In this scenario, an example of a label name is “Credit card inquiries” and an example of a label description for that label name is “Inquiries related to credit card issues, such as payment issues and fees.”

In step 210, the computer program may use a guideline agent to provide a large language model (LLM) with the label names and the corresponding descriptions and a prompt for initial annotation guidelines. An example prompt may be: “Help me design self-contained annotation guidelines that will be used to classify text. I want to see if customer queries can be classified into the following label name. Provide an initial draft for the guidelines and I will provide feedback.”

In step 215, the LLM may return the initial annotation guidelines. The initial annotation guidelines may define each label name and its label description in more detail.

In step 220, the computer program may receive an unlabeled dataset of samples. For example, the unlabeled dataset may include text samples that are not associated with a label name and/or label description.

In step 225, the computer program may use an annotation agent to predict a label name for each sample using the initial annotation guidelines. In one embodiment, the annotation agent may use retrieval augmented classification to efficiently classify the samples.

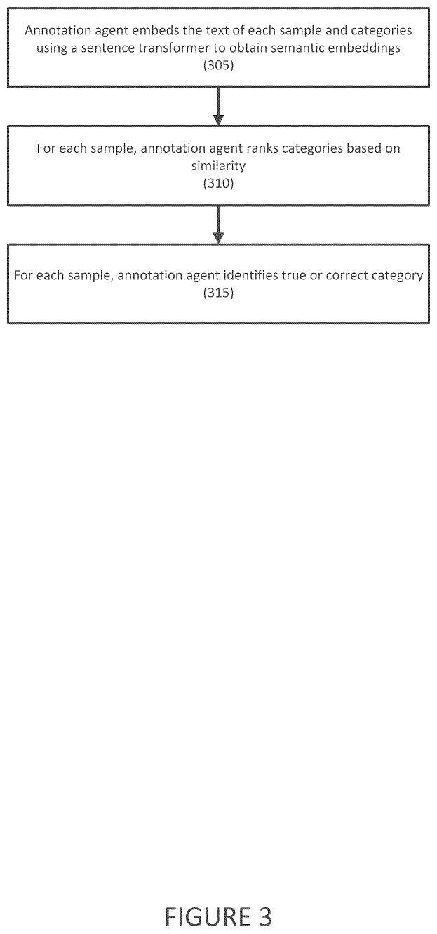

An example of an annotation process is provided in FIG. 3

In step 305, the annotation agent may embed the text of each sample and the label names using a sentence transformer to obtain semantic embeddings. For example, an all-mpnet-base-v2 sentence transformer model can be used to generate semantic embeddings.

In step 310, for each sample, the annotation agent may rank the label names in order of most similar to text to least similar. For example, the annotation agent may compute the cosine similarity of the text embedding and the label name embedding. Those with higher cosine similarity are assigned a higher semantic similarity score.

In one embodiment, the number of ranked label names may be limited.

In step 315, for each label name, the annotation agent may continue down the ranked list of label names until one of them outputs the true or correct output. An example of an LLM that can be used with the annotation agent is Mistral 7B.

Referring again to FIGS. 2A and 2B, in step 230, the computer program may present each sample and the predicted label name to a human for review. For example, the sample and the predicted label name may be presented on a user electronic device, and the user may indicate whether the predicted label name is correct or incorrect.

In step 235, if the predicted label name is incorrect, in step 240, the computer program may group the incorrectly labeled sample/label name pairs.

If the predicted label name is correct, or following step 240, if, in step 245, there are additional samples to review, the process may return to step 230.

In step 250, once the review is complete, the computer program may provide a LLM with the incorrectly labeled samples/label name pairs, the label name description for each label name, and the initial annotation guidelines with a prompt for recommendation to improve the initial annotation guidelines. The LLM may be the same LLM that was used before, or it may be a different LLM.

An example of a prompt is: “I've found a problem with my annotation guidelines. Using the initial version of the guidelines, and a description of the problem I encountered when using them for annotation, please write me a recommendation of how they can be improved. The initial guidelines are insufficient to label the following sample for the following reason. Tell me how the initial guidelines can be improved.”

In step 255, the LLM may return recommendations for improving the initial annotation guidelines. For example, for each label name that had incorrectly labeled samples, the LLM may return recommendations on how to improve the initial guidelines. An example of a recommendation is “This annotation guideline is not sufficient because it does not include various types of credit card issues. Some issues to include are: onboarding, merchant payments, and expiration.”

In step 260, the computer program may provide a LLM with the initial annotation guidelines, the recommendations, the incorrectly labeled sample/label name pairs, and the descriptions of label names with a prompt for improved annotation guidelines.

An example of a prompt is “You are an accurate and helpful assistant designed to help me improve my data annotation guidelines. The following label name, label description, and annotation guidelines have been used to annotate data, but I've found some problems. Label Name and Description: {label_and_description} Annotation Guidelines: {guidelines} The current version of the guidelines was not suitable to annotate the following samples of text. The task was to answer ‘Yes’ if sample belongs to the label name, otherwise ‘No’. {failure_string} Here are some recommended improvements: {recommendations} Using the information available in the failed samples and recommended improvements, provide improved concise step-by-step annotation instructions that can be followed by an annotator to identify text that belongs to the label name. The improved guidelines should be self-contained, and include all the information required for the annotator label accurately. The improved guidelines should be able to correctly annotate the samples that previously failed. The improved guidelines should not include the label and description. You can include up to 10 instructions in the improved guidelines. The improved guidelines should finish with a final step instructing the user to answer with ‘Yes’ if text belongs to the label name, otherwise ‘No’. Annotation Guidelines:’ Note that you can use the same or different LLM for this process.”

In step 265, the LLM may return the improved annotation guidelines.

In step 270, the improved annotation guidelines may be deployed to a production environment.

In step 275, the annotation agent may predict label names for samples received in the production environment. In one embodiment, multiple versions of the annotation guidelines (e.g., the initial annotation guidelines, the improved annotation guidelines, and any subsequent improvements) may be used to predict the label names for each sample, and a label model, such as Snorkel, may be used to combine the results and output a final predicted label name.

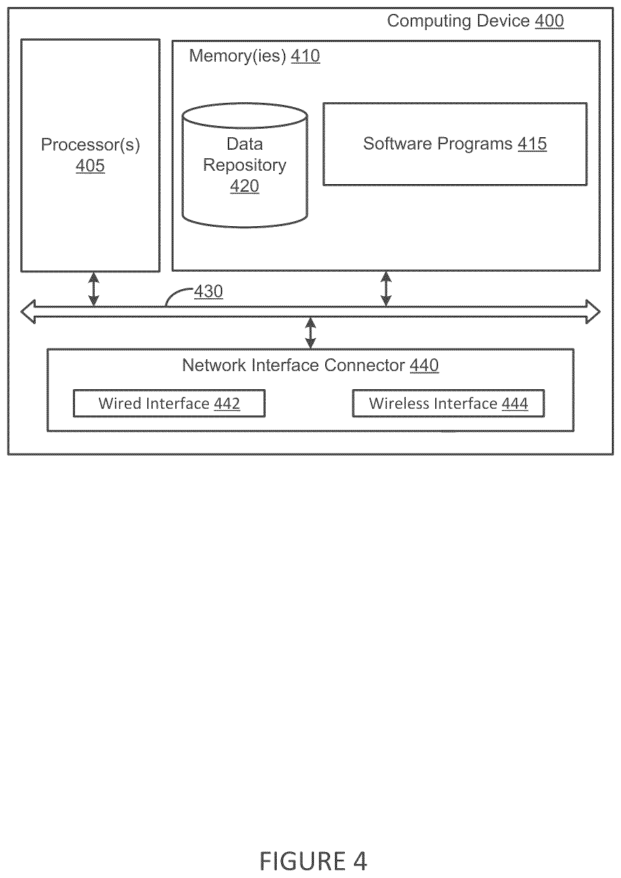

FIG. 4 depicts an exemplary computing system for implementing aspects of the present disclosure. FIG. 4 depicts exemplary computing device 400. Computing device 400 may represent the system components described herein. Computing device 400 may include processor 405 that may be coupled to memory 410. Memory 410 may include volatile memory. Processor 405 may execute computer-executable program code stored in memory 410, such as software programs 415. Software programs 415 may include one or more of the logical steps disclosed herein as a programmatic instruction, which may be executed by processor 405. Memory 410 may also include data repository 420, which may be nonvolatile memory for data persistence. Processor 405 and memory 410 may be coupled by bus 430. Bus 430 may also be coupled to one or more network interface connectors 440, such as wired network interface 442 or wireless network interface 444. Computing device 400 may also have user interface components, such as a screen for displaying graphical user interfaces and receiving input from the user, a mouse, a keyboard and/or other input/output components (not shown).

Although multiple embodiments have been described, it should be recognized that these embodiments are not exclusive to each other, and that features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, by a computer program executed by a computer processor, a dataset comprising a plurality of label names and a label description for each label name;
prompting, by the computer program, a large language model (LLM) for initial annotation guidelines with the dataset;
receiving, by the computer program and from the LLM, the initial annotation guidelines;
receiving, by the computer program, an unlabeled dataset comprising unlabeled text samples;
predicting, by the computer program, a label name for each unlabeled text sample;
presenting, by the computer program, each unlabeled text sample and its predicted label name for review;
grouping, by the computer program, incorrectly labeled text samples and their predicted label names;
prompting, by the computer program, the LLM for a recommendation to improve the initial annotation guidelines with the group of the incorrectly labeled text samples and their predicted label names and the initial annotation guidelines;
receiving, by the computer program and from the LLM, the recommendation;
prompting, by the computer program, the LLM for improved annotation guidelines with the initial annotation guidelines and the recommendation;
receiving, by the computer program, the improved annotation guidelines; and
deploying, by the computer program, the improved annotation guidelines to a production environment.

2. The method of claim 1, wherein the step of predicting, by the computer program and using an annotation agent, the label name for each unlabeled text sample comprises:
obtaining, by the annotation agent and using a sentence transformer, a semantic embedding for each unlabeled sample text and for the label names;
ranking, by the annotation agent and for each unlabeled sample text, the label names based on a similarity between the semantic embeddings; and
identifying, by the annotation agent, one of the label names for each unlabeled sample text as the predicted label name.

3. The method of claim 2, wherein the similarity comprises a cosine similarity.

4. The method of claim 2, wherein a number of ranked label names is limited.

5. The method of claim 1, wherein each unlabeled text sample and its predicted label name are presented for review to a human.

6. The method of claim 1, wherein each unlabeled text sample and its predicted label name is identified as correctly labeled or incorrectly labeled.

7. The method of claim 1, wherein multiple versions of the annotation guidelines are used in the production environment to predict label names, and a label model combines the predicted label names and outputs a final predicted label name.

8. A system, comprising:
a database comprising a dataset comprising a plurality of label names and a label description for each label name;
a large language model (LLM); and
a computer program executed by an electronic device that is configured to receive the dataset from the database; prompt the LLM for initial annotation guidelines with the dataset; receive, from the LLM, the initial annotation guidelines; receive an unlabeled dataset comprising unlabeled text samples; predict, a label name for each unlabeled text sample; present each unlabeled text sample and its predicted label name for review; group incorrectly labeled text samples and their predicted label names; prompt the LLM for a recommendation to improve the initial annotation guidelines with the group of the incorrectly labeled text samples and their predicted label names and the initial annotation guidelines; receive, from the LLM, the recommendation; prompt the LLM for improved annotation guidelines with the initial annotation guidelines and the recommendation; receive the improved annotation guidelines; and deploy the improved annotation guidelines to a production environment.

9. The system of claim 8, wherein predicting the label name for each unlabeled text sample comprises:
obtaining, using a sentence transformer, a semantic embedding for each unlabeled sample text and for the label names;
ranking, for each unlabeled sample text, the label names based on a similarity between the semantic embeddings; and
identifying one of the label names for each unlabeled sample text as the predicted label name.

10. The system of claim 9, wherein the similarity comprises a cosine similarity.

11. The system of claim 9, wherein a number of ranked label names is limited.

12. The system of claim 8, wherein each unlabeled text sample and its predicted label name are presented for review to a human.

13. The system of claim 8, wherein each unlabeled text sample and its predicted label name is identified as correctly labeled or incorrectly labeled.

14. The system of claim 8, wherein multiple versions of the annotation guidelines are used in the production environment to predict label names, and a label model combines the predicted label names and outputs a final predicted label name.

15. A non-transitory computer readable storage medium, including instructions stored thereon, which when read and executed by one or more computer processors, cause the one or more computer processors to perform steps comprising:
receiving a dataset comprising a plurality of label names and a label description for each label name;
prompting a large language model (LLM) for initial annotation guidelines with the dataset;
receiving, from the LLM, the initial annotation guidelines;
receiving an unlabeled dataset comprising unlabeled text samples;
predicting a label name for each unlabeled text sample;
presenting each unlabeled text sample and its predicted label name for review;
grouping incorrectly labeled text samples and their predicted label names;
prompting the LLM for a recommendation to improve the initial annotation guidelines with the group of the incorrectly labeled text samples and their predicted label names and the initial annotation guidelines;
receiving, from the LLM, the recommendation;
prompting the LLM for improved annotation guidelines with the initial annotation guidelines and the recommendation;
receiving the improved annotation guidelines; and
deploying the improved annotation guidelines to a production environment.

16. The non-transitory computer readable storage medium of claim 15, further including instructions stored thereon, which when read and executed by the one or more computer processors, cause the one or more computer processors to predict the label name for each unlabeled text sample by:
obtaining, using a sentence transformer, a semantic embedding for each unlabeled sample text and for the label names;
ranking, for each unlabeled sample text, the label names based on a similarity between the semantic embeddings; and
identifying, one of the label names for each unlabeled sample text as the predicted label name.

17. The non-transitory computer readable storage medium of claim 16, wherein the similarity comprises a cosine similarity.

18. The non-transitory computer readable storage medium of claim 16, wherein a number of ranked label names is limited.

19. The non-transitory computer readable storage medium of claim 15, wherein each unlabeled text sample and its predicted label name are presented for review to a human, and each unlabeled text sample and its predicted label name is identified as correctly labeled or incorrectly labeled.

20. The non-transitory computer readable storage medium of claim 15, wherein multiple versions of the annotation guidelines are used in the production environment to predict label names, and a label model combines the predicted label names and outputs a final predicted label name.
